(19) United States
(12) Patent Application Publication
(10) Pub. No.: US 2019/0202667 A1
(43) Pub. Date: Jul. 4, 2019

(54) METHOD AND TESTING DEVICE FOR DETERMINING A STATE OF A SUSPENSION TRACTION APPARATUS OF AN ELEVATOR SYSTEM

(71) Applicant: Inventio AG, Hergiswil (CH)

(72) Inventor: Fan Zhang, Hergiswil (CH)

(21) Appl. No.: 16/326,747

(22) PCT Filed: Aug. 22, 2017
(86) PCT No.: PCT/EP2017/071149

§ 371 Date: Feb. 20, 2019

(30) Foreign Application Priority Data
Aug. 24, 2016 (EP) 16185464.1

(51) Int. Cl. B66B 7/12; B66B 9/00; B66B 1/28; G01N 27/02; D07B 1/14; D07B 1/06

(52) U.S. Cl. CPC B66B 7/1223; B66B 9/00; B66B 1/28; G01N 27/028; D07B 1/145; D07B 2205/3025; D07B 2501/2007; D07B 2201/2041; D07B 2201/2087; D07B 2201/2092; D07B 1/068

(57) ABSTRACT

A method for determining a state of an elevator system suspension traction apparatus having at least one electrically conductive cord with a first end and an opposite second end, the cord having a wave impedance. A signal generator is electrically connected to the cord first end and a terminating resistor having a first resistance value matched to the wave impedance of the cord is electrically connected to the cord second end. The method includes the steps: inputting an, in particular alternating, electrical excitation signal of the signal generator into the cord first end; at least one of measuring a reflection signal of the excitation signal at the cord first end, and measuring a transmitted signal of the excitation signal at the cord second end; and determining the state of the suspension traction apparatus by comparing the excitation signal with at least one of the reflection signal and the transmitted signal.

### FIELD

The present invention relates to a method for determining a state of a suspension traction means of an elevator system, a testing device for determining a state of a suspension traction means of an elevator system and an elevator system with such a testing device.

### BACKGROUND

Elevators typically comprise a car and, in most cases, a counterweight which may be displaced for example within an elevator hoistway to different levels in order to transport persons or items for example to various levels within a building.

In a common type of elevator, the car and/or the counterweight are supported by a suspension traction means arrangement comprising one or generally more suspension traction means. The suspension traction means or suspension traction apparatus is typically an elongate member such as a rope or a belt. On the one hand, the suspension traction means may carry heavy loads in a tension direction and may be bent in a direction transverse to the tension direction. Accordingly, the suspension traction means may suspend the loads of the car and/or the counterweight. On the other hand, the car and/or the counterweight are generally displaced throughout the elevator hoistway by displacing the suspension traction means suspending these movable components. In most cases, the suspension traction means are wound around a traction sheave being driven into rotation by a drive engine such that due to traction between the traction sheave and the traction suspension means, the latter may be displaced.

Typically, the suspension traction means comprises one or more several cords.

In today's elevators, the suspension traction means such as a rope or a belt generally comprises a plurality of cords. In most cases, the cords are enclosed or encapsulated in a matrix material such as an elastomer. Each of the cords may comprise a multiplicity of strands. Therein, a strand may be a thin elongate fiber or wire. Conventionally, the strands may be made for example with a metal such as steel. However, modern types of strands may also comprise other materials. For example, strands may be made with heavily loadable fibers such as carbon fibers, glass fibers, aramid fibers, etc.

The suspension traction means of an elevator system is/are a security relevant part. If one or more cords of the suspension traction means deteriorate or tear/rip, in extreme cases the elevator car cannot be moved safely anymore. Deterioration of the suspension traction means or cords should be detected before a cord of the suspension traction means tears and/or rips.

Modern suspension traction means of elevators are encapsulated normally so that an optical inspection of the suspension traction means or the incorporated cords after installing the suspension traction means is no longer possible or feasible. Often, the suspension traction means comprises several cords encapsulated in a belt made of polyurethane.

There may be a need for a method for determining a state of a suspension traction means of an elevator system at least partly overcoming the above mentioned deficiencies. In particular, there may be a need for a method for determining a state of a suspension traction means of an elevator system which may determine the status of a suspension traction means of an elevator system non-optically. Furthermore, there may be a need for a testing device for determining a state of a suspension traction means of an elevator system. In particular, there may be a need for a testing device for determining a state of a suspension traction means of an elevator system which allows to determine the state non-optically. Furthermore, there may be a need for enabling determining a state of the suspension traction means without necessarily measuring any electrical resistances. Also, there may be a need for an elevator system with a testing device which allows to determine the state of a suspension traction means of the elevator system non-optically.

### SUMMARY

According to first aspect of the present invention, a method for determining a state of a suspension traction means of an elevator system is proposed, the suspension traction means comprising at least one electrically conductive cord having a first end and an opposite second end, the cord having a wave impedance, wherein a signal generator is electrically connected to the first end of the cord and a terminating resistor having a first resistance value matched to the wave impedance of the cord is electrically connected to the second end of the cord, the method comprising the steps: inputting an, in particular alternating, electrical excitation signal of the signal generator into the first end of the cord, at least one of measuring a reflection signal of the excitation signal at the first end of the cord and measuring a transmitted signal of the excitation signal at the second end of the cord, and determining the state of the suspension traction means based on a comparison of the excitation signal with at least one of the reflection signal and the transmitted signal.

One advantage thereof is that the status of an encapsulated suspension traction means can be tested non-optically. Also, deterioration of the cord can normally be detected, before a tear/rip of the cord occurs. Thus, the security of the elevator system in general is enhanced by this. The terminating resistor can also be e.g. a load resistor or an input resistor of an electrical network.

According to a second aspect of the present invention, a testing device for determining a state of a suspension traction means of an elevator system is proposed, wherein the suspension traction means comprises at least one electrically conductive cord having a first end and an opposite second end, the cord having a wave impedance, the testing device comprising: a signal generator for generating an, in particular alternating, electrical excitation signal, wherein the signal generator is connected to the first end of cord; a terminating resistor, wherein the terminating resistor has a first resistance value matched to the wave impedance of the cord and is connected to the second end of the cord; at least one of a first detector for measuring a reflection signal of the excitation signal, wherein the first detector is connected to the first end of the cord, and a second detector for detecting a transmitted signal of the excitation signal, wherein the second detector is connected to the second end of the cord, and a control device for comparing the excitation signal with the reflection signal and/or the transmitted signal and for determining the state of the suspension traction means based on a comparison of the excitation signal with at least one of the reflection signal and the transmitted signal.

One advantage thereof is that the status of an encapsulated suspension traction means can be tested non-optically. Also, typically, deterioration of the cord of the suspension traction means can be detected, before a tear/rip of the cord occurs. Thus, the security of the elevator system is enhanced by this in general.

According to a third aspect, an elevator system is proposed, comprising an elevator car, at least one suspension traction means for holding the car and moving the car, wherein the suspension traction means comprises at least one electrically conductive cord having a first end and an opposite second end, wherein the cord has a wave impedance, and a testing device according to the second aspect of the invention.

Ideas underlying embodiments of the present invention may be interpreted as being based, inter alia, on the following observations and recognitions.

A cord of a suspension traction means is a security relevant part, so the state of the cord should be determined or monitored, in particular during operation of the elevator system without interrupting the operation of the elevator system, so that changes and/or deteriorations of the cord can be detected at an early stage. Changes of the cord and/or of the environment of the cord typically changes the impedance of the cord for the excitation signal. Thus, such changes of the cord and/or of the environment of the cord can be determined. Furthermore, in general, no (direct) measurement of the impedance of the cord is necessary.

The occurring of a fissure in the suspension traction means and/or in the casing of the suspension traction means can be detected, when, e.g., water or moisture enters into the fissure. Typically, this changes the impedance of the cord. Thus, even though, the cord itself has not deteriorated (yet), a change of the state of the cord can be detected, in general.

According to an embodiment, the cord is a metal or metal alloy cable, in particular a steel cable. The cord means can be encapsulated with several other cords, for example in a belt matrix material made of polyurethane. The suspension traction means is adapted for holding the car and moving the car.

According to an embodiment, when the reflection signal is correlated or cross-correlated with the excitation signal a warning signal is generated and/or the operation of the elevator system is stopped. A correlation between signals means a signal similarity. Two or more signals which are correlated with each other have a similarity in their signal frequency, signal bandwidth and signal amplitude. To compare similarity between signals you can for example use a cross-correlation. The cross-correlation is a measure of similarity of two series as a function of the lag of one relative to the other. A cross-correlation can be performed between signals with different lengths too, but it is essential to ensure that they have identical sampling rates. When the resistance value of the terminating resistor is equal or correlated with the wave impedance of the cord of the suspension traction means, normally no reflection of the excitation signal occurs. Therefore, if part of the excitation signal is reflected at the second end of the cord, the wave impedance of the cord has changed from its original value normally. This indicates a change in the status of the cord and/or a deterioration of the cord and, thus, of the suspension transaction means. By doing this, in general, deteriorations of cord and the suspension traction means can be detected very early. Also, a tear/rip of the cord changes the impedance of the cord and, thus, creates a reflection of the excitation signal. Therefore, rips/tears of the cord can normally be detected, too. Thus, the security of the elevator system is further enhanced typically. When (essentially) no reflection signal is measured, the reflection signal is uncorrelated with the excitation signal.

According to an embodiment, when the transmitted signal is uncorrelated with or non-similar to the excitation signal, a warning signal is generated and/or the operation of the elevator system is stopped. When the resistance value of the terminating resistor is equal or correlated with the wave impedance of cord for the excitation signal, the excitation signal should be transmitted essentially without attenuation, i.e., the transmitted signal is essentially the same as the excitation signal typically. If the excitation signal is not similar to the transmitted signal, the wave impedance of the cord has changed which indicates a deterioration of the cord, and thus, of the suspension traction means normally. Also, a tear/rip of the cord leads to the state that the excitation signal is not essentially the same as the transmitted signal, since the transmitted signal is essentially zero. Therefore, rips/tears of the cords can be detected generally, too. Thus, security of the elevator system is further enhanced.

According to an embodiment, when at least one of the conditions that the transmitted signal is uncorrelated with or non-similar to the excitation signal and that the reflection signal is correlated with or similar to the excitation signal is fulfilled, the first resistance value of the terminating resistor is changed to a new second resistance value such that the reflection signal is uncorrelated with the excitation signal and/or such that the transmitted signal is correlated with the excitation signal. By this, the amount of change of wave impedance of the cord can be determined typically. Thus, further information about the change in status of the cord, and thus, of the suspension traction means and/or deterioration of the cord of the suspension traction means can be gathered. This further enhances the security in general.

According to an embodiment, when the difference between the first resistance value and the second resistance value exceeds a minimum difference value, a warning signal is generated and/or the operation of the elevator system is stopped. By this, typically, smaller changes in the wave impedance of the cord which are no indication that a tear/rip of the cord is immanent can be considered not relevant or not very relevant for the security of the elevator system. Thus, in general, no unnecessary warning signals and/or stoppings of the operation of the elevator system occur.

The first resistance value of the terminating resistor can be matched to the wave impedance value of the cord for the excitation signal via a potentiometer. Thus, typically, the resistance value of the terminating resistor can be changed easily.

According to an embodiment, the reflection signal is considered as being correlated or cross-correlated with the excitation signal when the difference in frequency between the reflection signal and the excitation signal is less than 5%, favorably less than 3%, more favorably less than 1%. The values are given as percentages of the frequency of the excitation signal.

According to an embodiment, the transmitted signal is considered as being uncorrelated with or non-similar to the excitation signal when the difference in frequency between the transmitted signal and the excitation signal is more than 1%, favorably more than 3%, more favorably more than 5%. The values are given as percentages of the frequency of the excitation signal.

According to an embodiment, the reflection signal is considered as being correlated or cross-correlated with the excitation signal when the difference in amplitude, in particular the maximum amplitude, between the reflection signal and the excitation signal is less than 5%, favorably less than 3%, more favorably less than 1%, and/or the transmitted signal is considered as being uncorrelated with the excitation signal when the difference in amplitude, in particular the maximum amplitude, between the transmitted signal and the excitation signal is more than 1%, favorably more than 3%, more favorably more than 5%. The values are given as percentages of the amplitude of the excitation signal.

According to an embodiment, the excitation signal has a peak width, in particular a rectangular wave form with a peak width, and the transmitted signal is considered as being uncorrelated with the excitation signal, when a peak width of the transmitted signal deviates from the peak width of the excitation signal by more than 1%, favorably more than 3%, more favorably more than 5%. The values are given as percentages of the peak width of the excitation signal.

According to an embodiment, the control device is configured for at least one of generating a warning signal and stopping the operation of the elevator system, when the reflection signal is correlated with the excitation signal. When the resistance value of the terminating resistor is equal or very similar to the wave impedance of the cord, no reflection of the excitation signal occurs typically. Therefore, if part of the excitation signal is reflected at the second of the cord, the wave impedance of the cord has changed from its original value in general. This indicates a change in the status of the cord, and thus, in suspension traction means and/or a deterioration of the cord of the suspension traction means typically. By doing this, deteriorations of the cords can be detected very early in general. Also, a tear/rip of the cord changes the impedance of the cord and, thus, creates a reflection of the excitation signal typically. Therefore, in general, rips/tears of the cord can be detected, too. Thus, the security of the elevator system is further enhanced in general.

According to an embodiment, the control device is configured for at least one of generating a warning signal and stopping the operation of the elevator system, when the transmitted signal is uncorrelated with the excitation signal. When the resistance value of the terminating resistor is equal or very similar to the wave impedance of the cord, the excitation signal should be transmitted essentially without attenuation, i.e., the transmitted signal is essentially the same as the excitation signal typically. If the excitation signal is not similar to the transmitted signal, the wave impedance of the cord has changed which indicates a deterioration of the cord in general. Also, a tear/rip of the cord leads to the state that the excitation signal is not essentially the same as the transmitted signal, since the transmitted signal is essentially zero. Therefore, rips/tears of the cord can be detected, too. Thus, security of the elevator system is further enhanced in general. Furthermore, usually, in the case of a shirt-circuit only the peaks of the excitation signal are measured at the second detector. Thus, the transmitted signal is uncorrelated with or not similar to the excitation signal in case of a short-circuit.

According to an embodiment, the terminating resistor is a potentiometer for adjusting the resistance value of the terminating resistor. Thus, the resistance value of the terminating resistor can be changed easily and can easily be matched to the wave impedance of the cord for the frequency of the excitation signal typically.

According to an embodiment, the control device is configured for changing the first resistance value of the potentiometer to a new second resistance value such that the reflection signal is uncorrelated with the excitation signal and/or such that the transmitted signal is correlated with the excitation signal, when at least one of the conditions that the transmitted signal is uncorrelated with the excitation signal and that the reflection signal is correlated with the excitation signal is fulfilled. By this, the amount of change of wave impedance of the cord can be determined typically. Thus, further information about the change in status of the cord, and thus, of the suspension traction means and/or deterioration of the cord of the suspension traction means can be gathered. This further enhances the security in general.

In particular, the transmitted signal of the excitation signal is correlated with or similar to the excitation signal, e.g., a rectangular wave form, when the transmitted signal has essentially the same form as the excitation signal and/or essentially the same frequency, e.g., the transmitted signal also has a rectangular wave form or an essentially rectangular wave form. The amplitude of the transmitted signal does not have to be and is normally not exactly as large as the amplitude of the excitation signal, even though the signals are considered to be similar to each other.

The same applies to the reflection signal in relation to the excitation signal.

In particular, the transmitted signal may be interpreted as being uncorrelated with or non-similar to the excitation signal when the difference in frequency between the two signals is more than 0.5%, favorably more than 1%, more favorably more than 3%, even more favorably more than 5% and even more favorably more than 10%> (the values are given as percentages of the frequency of the excitation signal). The same may apply to the amplitude, in particular the maximum amplitude, of the transmitted signal in relation to the amplitude, in particular the maximum amplitude, of the excitation signal. The corners or edges of a rectangular excitation signal can be rounded in the transmitted signal, i.e., the corners or edges of the transmitted signal may be smeared. If the cited percentages are not given, i.e., the difference between the signals is smaller than the given percentage values, the transmitted signal may be interpreted as being similar to the excitation signal.

In particular, the reflection signal may be interpreted as being correlated with or similar to the excitation signal when the difference in frequency between the two signals is less than 10%), favorably less than 5%>, more favorably less than 3%>, even more favorably less than 1%), and even more favorably less than 0.5% (the values are given as percentages of the frequency of the excitation signal). The same may apply to the amplitude, in particular the maximum amplitude, of the reflection signal in relation to the amplitude, in particular the maximum amplitude, of the excitation signal. If the cited percentages are not given, i.e., the difference between the signals is larger than the given percentage values, the reflection signal may be interpreted as being non-similar to the excitation signal. If an essentially zero reflection signal is measured, the reflection signal may be interpreted as being non-similar to the excitation signal (if the excitation signal is non-zero).

Furthermore, the transmitted signal may be interpreted as being uncorrelated with or non-similar to a (rectangular) excitation signal, when the width of the peak of a (essentially rectangular) transmitted signal deviates from the width of the peak of the excitation signal by more than 0.5%, in particular more than 1%, favorably more than 3%, even more favorably more than 5%, and even more favorably more than 10%. If the cited percentages are not given, i.e., the difference between the signals is smaller than the given percentage values, the transmitted signal may be interpreted as being similar to the excitation signal.

The excitation signal can be an alternating current signal. The excitation signal can be a high frequency signal, e.g., larger than 20 kHz, in particular larger than 1 MHz. The frequency can be below 30 MHz, in particular below 20 MHz. For this frequency range the wave impedance of the suspension traction means has a real value, normally in the range of a few dozens ohm. The frequency can be between 1 MHz and 20 MHz, for example. Also, the excitation signal can be a pulsed signal.

In the following, advantageous embodiments of the invention will be described with reference to the enclosed drawings. However, neither the drawings nor the description shall be interpreted as limiting the invention.

### DESCRIPTION OF THE DRAWINGS

FIG. 1 shows a traction-type elevator in which the testing device according to an embodiment of the present invention may be used;

FIG. 2 shows a perspective view of the suspension transaction means of FIG. 1; and

FIG. 3 shows a schematic view of an embodiment of a testing device according to the present invention.

The figures are only schematic and not to scale. Same reference signs refer to same or similar features.

### DETAILED DESCRIPTION

FIG. 1 shows a traction-type elevator 1 in which the testing device according to an embodiment of the present invention may be used.

The elevator 1 comprises a car 3 and a counterweight 5 which may be displaced vertically within an elevator shaft 7. The car 3 and the counterweight 5 are suspended by a suspension traction means arrangement 9. This suspension traction means arrangement 9 comprises one or more suspension traction means or suspension traction apparatus 11. Such suspension traction means 11 may be for example ropes, belts, etc. in which cords are embedded in a jacket. In the arrangement shown in FIG. 1, end portions of the suspension traction means 11 are fixed to supporting structures 12 of the elevator 1 at a top of the elevator shaft 7.

The suspension traction means 11 may be displaced using a drive engine 13 driving a traction sheave 15. Therein, the suspension transaction means 11 may be wound around a traction surface of the traction sheave 15 and may furthermore be wound around pulleys 16 attached to the car 3. An operation of the drive engine 13 may be controlled by an elevator control device 17.

It may be noted that the elevator 1 and particularly its suspension traction means 11 may be configured and arranged in various other ways than those shown in FIG. 1.

The suspension traction means 11 to be driven for example by the drive engine 13 may utilize metal cords or ropes to support a suspended load such as the car 3 and/or the counterweight 5 that is moved by the drive engine 13.

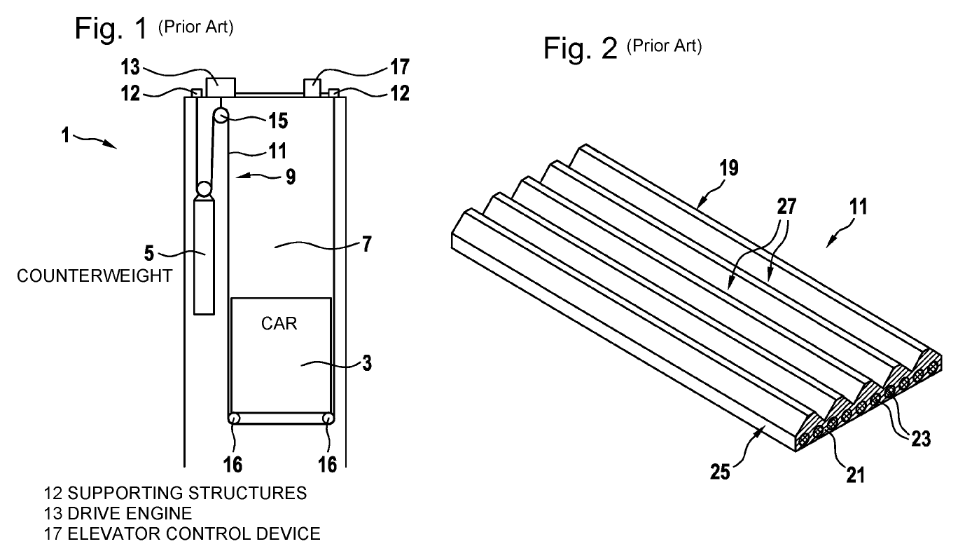

FIG. 2 shows a perspective view of the suspension transaction means 11 of FIG. 1 being implemented as a belt 19. The belt 19 comprises a plurality of cords 23 which are arranged parallel to and spaced from each other. The cords 23 are enclosed in a jacket material 21 forming, inter alia, a jacket 25. Such jacket 25 may mechanically couple neighboring cords 23. Furthermore, the jacket 25 may protect the cords 23 against for example mechanical damages and/or corrosion. The jacket 25 may have a textured or profiled traction surface including longitudinal guiding grooves 27. The cords 23 may typically conventionally consist of or comprise multiple strands formed by wires made from a metal such as steel. The jacket material 21 may consist of or comprises a plastic or elastomeric material such as polyurethane.

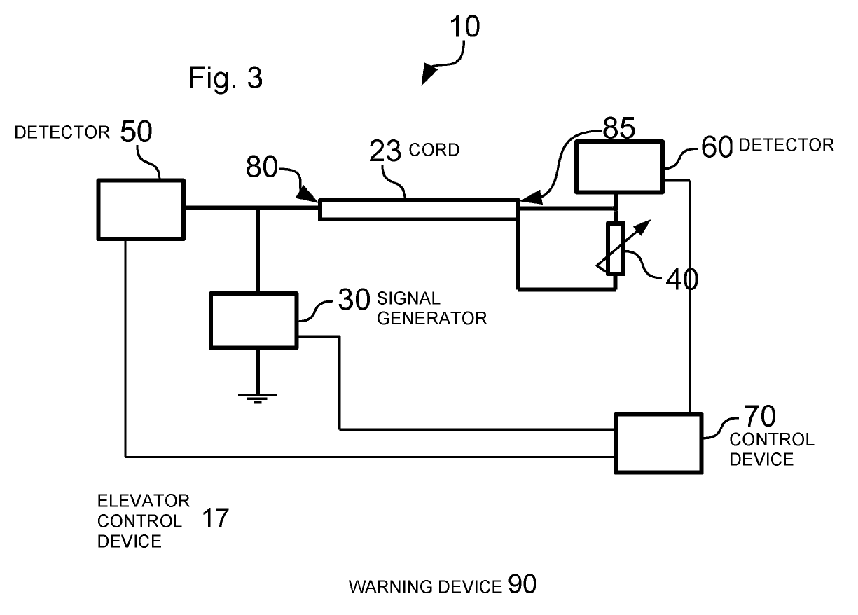

FIG. 3 shows a schematic view of an embodiment of a testing device 10 according to the present invention. The testing device 10 comprises a signal generator 30, a potentiometer 40, a control device 70 and a first detector 50 and/or a second detector 60. The testing device 10 is adapted for testing a cord 23 of a suspension traction means 11 or several cords 23 of one or several suspension traction means 11 of an elevator system, i.e., the cord which carries the car. The cords 23 can be encapsulated, in particular together with other cords 23. The cord(s) 23 can be encapsulated in a belt made of polyurethane. The cord 23 is tested by the testing device 10 in situ, i.e., after the cord 23 has been installed (and has been used). The testing device 10 tests the status of the cord 23, and, thus, of the suspension traction means 11 during the operation of the elevator system. The testing can be done while the car of the elevator system is not moved. Alternatively, the cord 23 can be tested before being installed in the elevator system and/or after they have been removed from the elevator system.

The testing of the cord 23 can be done in intervals with pauses in between or continuously.

The signal generator 30 is (electrically) connected to a first end 80 of the cord 23. The first end 80 of the cord 23 can also enclose a small region which is very close to the physical first end/tip of the cord 23. The first detector 50 is also connected to the first end 80 of the cord 23. The second detector 60 is connected (electrically) to the second end 85 of the cord 23, wherein the second end 85 of the cord 23 is opposite to the first end 80 of the cord 23. The second end 85 of the cord 23 can also enclose a small region which is very close to the physical second end/tip of the cord 23. The potentiometer 40 is (electrically) connected to the second end 85 of the cord 23. The potentiometer 40 is connected in parallel to an electrical connection leading directly from the second end 85 of the cord 23 to the second detector 60.

The control device 70 is (electrically) connected to the signal generator 30, the first detector 50, the second detector 60 and the potentiometer 40. The control device 70 controls the signal generator 30, the first detector 50, the second detector 60 and the potentiometer 40.

The signal generator 30 generates an excitation signal. The excitation signal can be a high-frequency signal. The frequency can be set to a set value (e.g., 5 MHz) or can be changed during the testing. For example, the excitation signal can be a rectangular signal with a set frequency. Other kinds of excitation signals (sinus, triangular etc.) are possible.

The resistance value of the potentiometer 40 (which is the terminating resistor) is adjusted such that the resistance value of the potentiometer 40 is essentially the same as the wave impedance of the cord 23. Thus, the second end 85 of the cord 23 seems to be nonexistent for the excitation signal but the cord 23 seems to be indefinitely long for the excitation signal. Therefore, if the (first) resistance value of the potentiometer 40 is matched to the wave impedance value of the cord 23, no reflection of the signal should occur and the signal should be transmitted essentially without attenuation to the second detector 60. The wave impedance value and the resistance value are the respective values for the frequency of the excitation signal.

The excitation signal is input into the cord 23 at the first end 80 of the cord 23. If the resistance value of the potentiometer 40 is matched to the wave impedance value of the cord 23, the first detector 50 should detect no reflection signal. Thus, if a reflection signal is detected or measured by the first detector 50, wherein the reflection signal is correlated with or similar to the excitation signal (essentially the same form and/or essentially the same frequency), the wave impedance value of the cord 23 is different from the resistance value (or wave impedance value) of the potentiometer 40. Hence, the original wave impedance value of the cord 23 has changed. This indicates a change of the status/in the status of the cord 23 and, thus, of the suspension traction means 11, i.e., the cord 23 deteriorated and/or a tear/rip of the cord 23 or parts thereof has occurred. The control device 70 compares the measured reflection signal with the excitation signal.

If the reflection signal is correlated with or similar to the excitation signal (in particular has a similar form), a warning signal can be generated/issued by the control device 70 to a warning device 90. This warning signal can produce an optical or acoustic warning signal from the warning device 90 within the car 3 of the elevator system and/or at the central control of the elevator system. Also, the warning signal can lead to a stop of the operation of the elevator system by the elevator control device 17. The operation of the elevator system can be stopped, by moving the car to the next possible stop, opening the doors and requesting the passengers to leave the car (via optical and/or acoustic indicators/signals).

The second detector 60 measures/detects the transmitted signal of the excitation signal, i.e., the portion of the excitation signal which is transmitted. If the resistance value of the potentiometer 40 (the terminating resistor) is essentially the same as the wave impedance value of the cord 23 (for the excitation signal/the frequency of the excitation signal), the transmitted signal should be very similar to the excitation signal, i.e., having the same form with no or only minor attenuation and/or the same frequency. The control device 70 compares the transmitted signal with the excitation signal.

If the transmitted signal is uncorrelated with or non-similar to the excitation signal (frequency is different, form is different and/or amplitude is very different), a warning signal can be generated/issued by the control device 70 to the warning device 90. This warning signal can produce an optical or acoustic warning signal within the car of the elevator system and/or at the central control of the elevator system. Also, the warning signal can lead to a stop of the operation of the elevator system by the elevator control device 17. The operation of the elevator system can be stopped, by moving the car to the next possible stop, opening the doors and requesting the passengers to leave the car (via optical and/or acoustic indicators/signals).

Changes in the reflection signal and/or in the transmitted signal indicate a change of status of the cord 23 and, thus, in the status of the suspension traction means 11.

It is also possible, that the control device 70 tests or monitors several cords 23 of one suspension transaction means 11 or of several suspension transaction means 11 of an elevator system 1, e.g., ten suspension cords 23 or ten cables. Each cord 23 or cable can have a signal generator 30, a potentiometer 40 and a first detector 50 and/or second detector 60. Alternatively, several cords 23 or cables share a signal generator 30 and/or a first detector 50 and/or second detector 60. If a change of/in status is detected in only one or a few cables or cords 23, e.g., 2 or 3, no action needs to be taken normally, since there is a large enough safety buffer, i.e., the rest of the cables or cords 23 (e.g., 6 or 7) can carry the car 3 safely, even if one or more cable or cord 23 rip/tear. If more than a set number or set percentage of the cords 23 change status, a warning signal is generated and/or the operation of the elevator system 1 is stopped (as described in detail above).

If the control device 70 detects that the transmitted signal is not similar to the excitation signal and/or that the reflection signal is similar to the excitation signal, the control device 70 can adjust the resistance value of the potentiometer 40/terminating resistor such that the reflection signal is non-similar to the excitation signal and/or such that the transmitted signal is similar to the excitation signal. Thus, the resistance value of the potentiometer 40 is changed from a first resistance value (which is equal to the original wave impedance of the cord 23) to a new second resistance value (which is equal to the current wave impedance of the cord 23 for the excitation signal). If the difference between the first and second resistance value is small, i.e., smaller than a set minimum difference value (for example 2 ohm) or a set minimum percentage of the original resistance value (e.g., 10%), no current danger is present. No tear/rip of the cord 23 is immanent. If the difference between the first and second resistance value is equal or larger than the minimum difference value or the minimum difference percentage value, a warning signal can be issued and/or the operation of the elevator system can be stopped. Large changes in the status of the cord 23 indicate a possible rip/tear in the near future.

After adjusting the resistance value of the terminating resistor via the potentiometer 40, the monitoring/testing of the suspension traction means 11 can continue.

The warning signal can be transmitted to a central elevator system monitoring server. This can alert maintenance staff to further inspect the relevant suspension traction means 11. This further inspection can be done with x-rays or similar nondestructive testing method. Also, the changes in the resistance value of the terminating resistor/potentiometer 40 can be saved locally or sent to a central server where they can be used and/or saved.

The control device 70 can further analyze the reflection signal and/or the transmitted signal. In particular, the control device 70 can do a Fourier analysis of the reflection signal and/or the transmitted signal. Also, the amount of difference between the first resistance value and the second resistance value can be take into account by the control device 70.

Finally, it should be noted that the term “comprising” does not exclude other elements or steps and the “a” or “an” does not exclude a plurality. Also elements described in association with different embodiments may be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A method for determining a state of a suspension traction apparatus of an elevator system, the suspension traction apparatus including at least one cord being electrically conductive and having a first end and an opposite second end, the cord having a wave impedance, wherein a signal generator is electrically connected to the first end of the cord and a terminating resistor having a first resistance value matched to the wave impedance of the cord is electrically connected to the second end of the cord, the method comprising the steps of:
inputting an electrical excitation signal from the signal generator into the first end of the cord;
at least one of measuring a reflection signal of the excitation signal at the first end of the cord, and measuring a transmitted signal of the excitation signal at the second end of the cord;
determining a state of the suspension traction apparatus based on a comparison of the excitation signal with at least one of the reflection signal and the transmitted signal; and
at least one of generating a warning signal and controlling operation of the elevator system in response the determined state of the suspension traction apparatus.

17. The method according to claim 16 wherein when the reflection signal is correlated or cross-correlated with the excitation signal, at least one of the warning signal is generated and the operation of the elevator system is stopped.

18. The method according to claim 17 wherein the reflection signal is considered as being correlated or cross-correlated with the excitation signal when a difference in frequency between the reflection signal and the excitation signal is less than 5%.

19. The method according to claim 16 wherein when the transmitted signal is uncorrelated with the excitation signal, at least one of the warning signal is generated and the operation of the elevator system is stopped.

20. The method according to claim 19 wherein the transmitted signal is considered as being uncorrelated with the excitation signal when a difference in frequency between the transmitted signal and the excitation signal is more than 1%.

21. The method according to claim 16 wherein the first resistance value of the terminating resistor is changed to a new second resistance value when at least one of conditions that the transmitted signal is uncorrelated with the excitation signal and that the reflection signal is correlated with the excitation signal is fulfilled, such that at least one of the reflection signal is uncorrelated with the excitation signal and the transmitted signal is correlated with the excitation signal.

22. The method according to claim 21 wherein when a difference between the first resistance value and the second resistance value exceeds a minimum difference value, at least one of the warning signal is generated and the operation of the elevator system is stopped.

23. The method according to claim 16 wherein at least one of the warning signal is generated and the operation of the elevator system is stopped when at least one of the reflection signal is correlated or cross-correlated with the excitation signal based upon a difference in amplitude between the reflection signal and the excitation signal being less than 5%, and the transmitted signal is uncorrelated with the excitation signal based upon a difference in amplitude between the transmitted signal and the excitation signal being more than 1%.

24. The method according to claim 16 wherein at least one of the warning signal is generated and the operation of the elevator system is stopped when the excitation signal has a peak width and the transmitted signal is uncorrelated with the excitation signal based upon a peak width of the transmitted signal deviates from the peak width of the excitation signal by more than 1%.

25. A testing device for determining a state of a suspension traction apparatus of an elevator system, wherein the suspension traction apparatus includes at least one cord being electrically conductive and having a first end and an opposite second end, the cord having a wave impedance, the testing device comprising:
a signal generator generating an electrical excitation signal and being connected to the first end of the cord;
a terminating resistor having a first resistance value matched to the wave impedance of the cord and being connected to the second end of the cord;
at least one of a first detector for measuring a reflection signal of the excitation signal, wherein the first detector is connected to the first end of the cord, and a second detector for detecting a transmitted signal of the excitation signal, wherein the second detector is connected to the second end of the cord; and
a control device for comparing the excitation signal with at least one of the reflection signal and the transmitted signal and for determining the state of the suspension traction apparatus based on the comparison of the excitation signal with at least one of the reflection signal and the transmitted signal, the control device at least one of generating a warning signal and controlling operation of the elevator system in response the determined state of the suspension traction apparatus.

26. The testing device according to claim 25 wherein the control device is adapted to at least one of generate the warning signal and stop operation of the elevator system when the reflection signal is correlated with the excitation signal.

27. The testing device according to claim 25 wherein the control device is adapted to at least one of generate the warning signal and stop operation of the elevator system when the transmitted signal is uncorrelated with the excitation signal.

28. The testing device according to claim 25 wherein the terminating resistor is a potentiometer for adjusting the first resistance value of the terminating resistor.

29. The testing device according to claim 28 wherein the control device changes the first resistance value of the potentiometer to a new second resistance value when at least one of the transmitted signal is uncorrelated with the excitation signal and the reflection signal is correlated with the excitation signal such that at least one of the reflection signal is uncorrelated with the excitation signal and the transmitted signal is correlated with the excitation signal.

30. An elevator system comprising:
a car;
at least one suspension traction apparatus for holding the car and moving the car, wherein the at least one suspension traction apparatus includes at least one cord being electrically conductive and having a first end and an opposite second end, wherein the at least one cord has a wave impedance; and
a testing device according to claim 25 connected to the at least one cord.
